(19) United States
(12) Patent Application Publication
(10) Pub. No.: US 2011/0080806 A1
(43) Pub. Date: Apr. 7, 2011

(54) SYSTEM AND METHOD FOR GEOTHERMAL ACOUSTIC INTERFACE

(76) Inventor: Randy Allen Normann, (US)

(21) Appl. No.: 12/906,748

(22) Filed: Oct. 18, 2010

Related U.S. Application Data
(60) Provisional application No. 61/267,722, filed on Dec. 8, 2009.

(51) Int. Cl. G01V 1/48

(52) U.S. Cl. 367/35

(57) ABSTRACT

Systems and methods for subterranean imaging and logging are herein disclosed. In one embodiment, a subterranean tool for logging and imaging a subterranean well is provided. The subterranean tool includes a tool body, at least one transducer arranged within the tool body and an acoustic window coupled to the transducer.

### CROSS REFERENCE TO RELATED APPLICATIONS

This application claims priority from U.S. provisional application No. 61/267,722, entitled “SYSTEM AND METHOD FOR GEOTHERMAL ACOUSTIC INTERFACE” filed on Dec. 8, 2009, which is incorporated by reference in its entirety, for all purposes, herein.

### FIELD OF TECHNOLOGY

The present application is directed to systems and methods for subterranean imaging and logging. More particularly, the present application is directed to systems and methods for geothermal imaging and logging.

### BACKGROUND

Conventional subterranean logging tools use piezoelectric acoustic devices operating at ultrasonic frequencies to create downhole images of a subterranean well. The piezoelectric device is electrically charged and subsequently discharged, causing the device to increase and decrease in size respectively. The fluctuation in size of the device creates a pulse which displaces fluid within a subterranean well.

During acoustic imaging of a subterranean well or wellbore, an acoustic pulse is echoed or bounced off the wellbore wall. The time of flight of the acoustic signal is measured to determine the distance between the acoustic device producing the signal and the wellbore wall. The logging tool or a component part of the logging tool must be rotated to obtain time of flight measurements over a 360 degree circumference of the wellbore.

Prior art logging tools are not capable of operating in high temperature geothermal environments for several reasons. Corrosive and conductive fluids within geothermal wells can short-out, corrode or otherwise damage piezoelectric acoustic devices that are used to generate the acoustic signal. The tool must be filled with a nonconductive liquid to protect the device and prevent shorting. The nonconductive liquid is sealed from the wellbore fluid with an acoustically transparent window or televiewer usually constructed from PEEK or Teflon. The acoustic properties of PEEK and Teflon change drastically with temperature which will affect the accuracy of time of flight data and other data needed to generate an image of the wellbore.

The nonconductive fluid within the tool can undergo significant thermal expansion in geothermal or engineered geothermal systems having high operating temperatures greater than 260° C. Balancing the pressure of the fluid filled chamber with external well pressure is also difficult at high temperatures. Moving tool parts and seals within the tool can fail at high temperatures and prior art tools must operate in a liquid filled borehole. Many geothermal wells, steam flood wells and gas wells do not have liquid in the wellbore for operation of the tool. The prior art logging tools are not suitable for most geothermal, engineered geothermal, or oil and gas applications involving steam flood or high temperatures.

### SUMMARY

Systems and methods for subterranean imaging and logging are herein disclosed. In one embodiment, a subterranean tool for logging and imaging a subterranean well is provided. The subterranean tool includes a tool body, at least one transducer arranged within the tool body and an acoustic window coupled to the transducer.

The foregoing and other objects, features and advantages of the present disclosure will become more readily apparent from the following detailed description of exemplary embodiments as disclosed herein.

### BRIEF DESCRIPTION OF THE DRAWINGS

Embodiments of the present application are described, by way of example only, with reference to the attached Figures, wherein:

FIG. 1 illustrates an exemplary system for deploying an exemplary subterranean logging and imaging tool in a subterranean well;

FIG. 2 illustrates a cross sectional view of an exemplary subterranean logging and imaging tool according to one embodiment;

FIG. 3 illustrates a side perspective view of an exemplary subterranean logging and imaging tool according to another embodiment;

FIG. 4 illustrates an inverted perspective view of an exemplary transducer array according to one embodiment;

FIG. 5 illustrates an exemplary subterranean logging and imaging tool according to another embodiment;

FIG. 6 illustrates a cross sectional view of an exemplary calibration nose according to one embodiment;

FIG. 7 illustrates an exemplary electronics housing according to one embodiment; and

FIG. 8 illustrates a flow chart of an exemplary method for imaging a subterranean surface.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein. It will be understood by those of ordinary skill in the art that the systems and methods herein disclosed may be applied to subterranean wells including, but not limited to geothermal wells, oil wells, gas wells, water wells, injection wells or other well known in the art for producing or injecting fluids.

FIG. 1 illustrates an exemplary system 100 for deploying an exemplary subterranean logging and imaging tool 102 in a subterranean well 104. A logging vehicle 106 can provide a wire line spool 108. The wire line 110 can be single conductor wire line. The wire line is connected to a surface of the logging and imaging tool 102 and lowered passed the wellhead 112 to deploy the tool 102 into the subterranean well 104. Data collected by the logging and imaging tool 102 can be transmitted through a single conductor wire line 110 and processed by a processor at the surface or in the logging vehicle 106 real-time during logging. Other methods known in the art for deploying, lowering or spooling downhole tools into a subterranean well can also be used to position the tool 102 in the subterranean well 104.

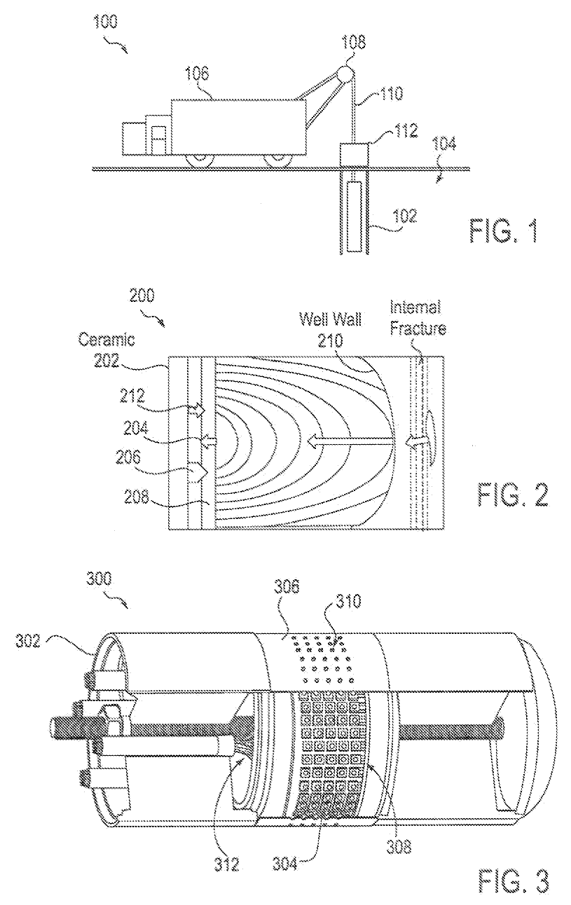

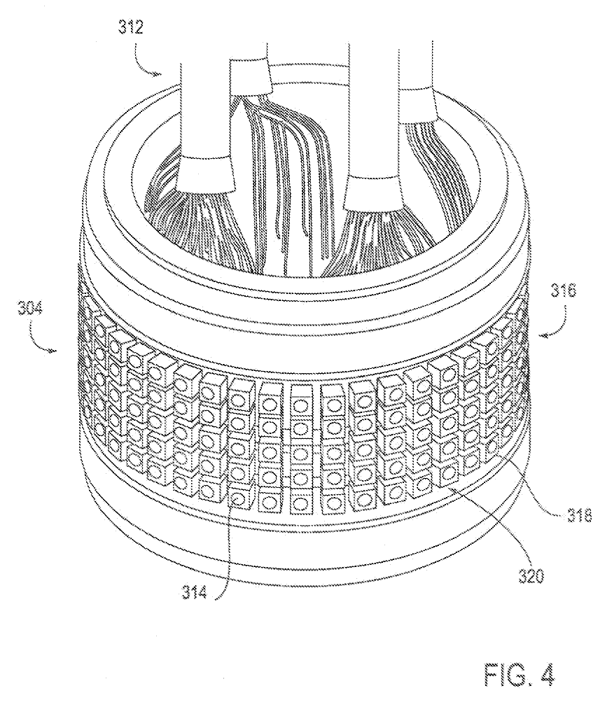

FIG. 2 illustrates a cross sectional view of an exemplary subterranean logging and imaging tool 200 according to one embodiment. The tool 200 can be deployed or lowered into a subterranean well to image the well, detect formation fractures, measure the diameter of the wellbore, investigate well casing, perforations, slots and screens, or detect corrosion and cracks in cement, well casing or other bonds between the casing, the cement and the formation.

The tool 200 includes a tool body 202 containing one or more acoustic transducers 204 for generating acoustic signals and an acoustic window 208 for transmitting the acoustic signals into the subterranean well. The transducers 204 are separated by small relief grooves 212 to reduce acoustic coupling between adjacent transducers 204.

The tool body 202 can be oblong, cylindrical, spherical or tube shaped. The tool body 202 can be constructed from at least one non-magnetic metal or metal alloy including, but not limited to steal, titanium, incoloid, ceramic or other corrosion resistant material with high temperature and pressure ratings. In an exemplary embodiment, the tool body 202 is constructed with a Dewar heat shield having a temperature rating of greater than 325° C.

The tool body 202 is sealed with an acoustic window 208 to protect the transducers 204 from high temperature and/or corrosive well fluids such as heated brine, steam, chlorine, sulfur and other corrosive or high temperature fluid within the subterranean well. The acoustic window 208 can be mechanically, electrically or acoustically coupled or placed in contact with a surface of one or more transducers 204 within the tool body 202. In an exemplary embodiment, the acoustic window 208 is mechanically, electrically and acoustically coupled to an anterior or active surface of one or more transducers 204 within the tool body 202. Primary acoustic signals used during operation of the tool 200 are emitted from an active surface of the transducers 204.

The acoustic window 208 provides an acoustic medium to transmit acoustic signals generated by the acoustic transducers 204. The acoustic window 208 is constructed from material that is chemically inert with well fluids. The acoustic window 208 is constructed from material with acoustical properties substantially similar to the acoustic properties of the transducers 204. This eliminates or reduces internal acoustical reflection within the tool 200. To reduce or eliminate internal reflection within the wellbore, it is also beneficial for the acoustic properties of the acoustic window 208 to be as similar as possible to the acoustic properties of the casing, the formation or cement between the formation and the casing. The acoustic properties (e.g., acoustic impedance) and mechanical properties of the acoustic window 208 are not strongly dependent upon temperature and remain substantially unaltered in temperature ranges encountered in geothermal and engineered geothermal systems. The acoustic window 208 can be constructed from at least one material including, but not limited to titanium, tin, lead alloys, zirconium, gallium-indium alloys, silver alloys, rare earth metals, rare earth metal alloys or other material exhibiting the properties described above.

In an exemplary embodiment, the acoustic properties and mechanical properties of the acoustic window remain substantially unaltered in a temperature range from about ambient temperature to temperatures greater than 275° C.

The following acoustic reflection equation can be used to determine the degree of acoustic reflection of an acoustic signal or pulse traveling through two acoustic mediums: % Reflection=100*((Z1−Z2)/(Z1+Z2))2; wherein Z1 and Z2 are the acoustic impedance of the two materials through which the acoustic pulse travels. An acoustically transparent material has an acoustic impendence near that of water (about 1 g/cm²-sec10⁵). When an acoustic signal travels through acoustically transparent materials, the acoustic reflection equation converges to 0 and no acoustic reflection is observed. Acoustical transparency can also be achieved within the tool body 202 by coupling two or more materials of similar acoustic impedance within the tool body 202. Therefore, the acoustic window 208 is constructed from material that has an acoustic impendence substantially similar to the acoustic impedance of the transducers 204 used to generate the acoustic signal. A non-conductive fluid or an acoustically transparent window is not required to operate the logging and imaging tool 200.

To eliminate or reduce internal reflection of the acoustic signal within the tool body 202, the acoustic window 208 is placed in direct contact with a surface of the acoustic transducers 204. The coupling of the acoustic window 208 and the transducers 204 can create acoustical transparency between the acoustic window 208 and the acoustic transducers 204.

The acoustic window 208 can be mechanically, electrically or acoustically bonded to one or more transducers 204 by soldering the acoustic window 208 to the transducers 204 with high temperature solder such as a gold eutectic solder. In an exemplary embodiment, the acoustic window 208 is mechanically, electrically and acoustically bonded or coupled to a front or active surface of one or more transducers 204 by soldering the acoustic window 208 to the transducers 204.

In geothermal and enhanced geothermal systems, the wellbore pressure can be equal to and greater than 1000 psi. Therefore, the acoustic window 208 can also be mechanically, electrically and acoustically bonded to one or more acoustic transducers 204 with the use of wellbore pressure.

The exterior surface of the acoustic window 208 can be treated with plated or sputtered metal to facilitate bonding of the solder to the surface of the acoustic window 208. The acoustic window 208 is electrically coupled to an earth ground or circuit common. Therefore, the acoustic window 208 can be in direct contact with corrosive and conductive wellbore fluid without shorting or damaging the tool 200.

To maximize acoustic transparency between the transducer 204 and the acoustic window 208, the thickness of the acoustic window 208 can be any multiple of ½ or ¼ of the acoustic wavelength (λ). The acoustic wavelength (λ) is a function of the acoustic velocity and frequency expressed in the following equation: λ=V/f; wherein (V) is the acoustic velocity and (f) is the acoustic frequency of an acoustic signal traveling through a given medium. The acoustic wavelength (λ) transmitted from one or more acoustic transducers 204 can range anywhere from about 0.01 mm to 50 mm depending on frequency (f) of the signal pulse and the velocity (V) of the signal traveling through a given well fluid at a given temperature. In an exemplary embodiment, the acoustic frequency (f) of the signal transmitted from one or more transducers 204 is about 1 MHz and the acoustic velocity (V) of the signal through water ranges from 1450 m/s at room temperature to 2680 m/s at 275° C. In another embodiment, the acoustic velocity (V) of the signal through air ranges from 331 m/s at 0° C. to 7760 m/s at 100° C.

The transducers 204 can also be treated with plated or sputtered metal to create electrically conductive surfaces on an anterior and/or posterior surface of the transducers 204. A posterior or rear surface of the transducers 204 can be electrically coupled to an active drive circuit (not shown) that drives the transducers to emit acoustic signals or pulses. One or more processors can be operatively connected to drive circuit and a corresponding power supply to fire or actuate the transducers 204. The processors can be programmed or provided with software configured to sequence or time the actuation of two or more transducers 204. The sequential actuation of transducers 204 allows the signals to be combined, amplified and focused on a particular spot on a subterranean surface.

The acoustic transducers 204 can be constructed from at least one piezoelectric material including, but not limited to lead zirconate titanate (PZT), tourmaline, topaz, quartz, lead metaniobate (K-83), and bimuth titanate (K-15). The acoustic impedance of these piezoelectric materials is about 25 to 35 g/cm²-sec10⁵.

For high temperature environments, such as geothermal and enhanced geothermal systems, the piezoelectric transducer must have a high Curie temperature (Tc). Once the well temperature exceeds 50% of the Tc, the operating life of the piezoelectric transducer is compromised. K-83 has a Tc of 570° C. and can be used in geothermal and enhanced geothermal systems depending on the number of well exposures. K-83 also has a high acoustic response. K-15 has a Tc of 600° C. and can withstand operating temperatures equal to and greater than 300° C. The acoustic impedance of K-15 is 29.0 g/cm²-sec10⁵. K-15 is suitable for use in geothermal and enhanced geothermal systems.

In an exemplary embodiment, the acoustic window 208 is constructed from titanium having an acoustic impedance of 27.3 g/cm²-sec10⁵ and the acoustic transducers 204 are constructed from K-15 having acoustic impedance of 29.0 g/cm²-sec10⁵. The acoustic window 208 is bonded to one or more K-15 transducers 204 with a gold eutectic solder. The difference in acoustic impedance between titanium acoustic window 208 and the K-15 transducers 204 is 1.7 g/cm²-sec10⁵. Substantially all internal reflection of the acoustic signal within the tool body 202 is eliminated by emitting the acoustic signal from one or more K-15 transducers 204 in direct contact with the titanium acoustic window 208. The use of a titanium acoustic window 208 also increases the pressure rating of the tool 200 to pressures equal to and greater than 20,000 psi. The logging and imaging tool 200 can operate without oil or bellows for pressure equalization. Removing oil from the tool 200 significantly reduces tool maintenance and improves the success rate in field operations.

An acoustic damper 206 can be mounted to or placed in acoustic contact with a rear or inactive surface of the transducers 204 within the tool body 202. The inactive surface of the transducers 204 are not used to generate the primary acoustic signal during operation of the tool 200. The acoustic damper can be mechanically bonded to a rear or inactive surface of the transducers 204 with a high temperature solder, such as a gold eutectic solder. The acoustic damper 206 is constructed from a matrix of acoustically stiff material that drives acoustic signals through the front or active side of the transducers 204. The impedance mismatch (Z1-Z2) between two or more materials within the acoustic damper 206 deadens or dampens ultrasonic ringing within the tool body 202 and drives the acoustic pulse through the acoustic window 208 and into the wellbore fluid.

The acoustic damper 206 can be constructed from at least one acoustically stiff material including, but not limited to ceramic, tungsten, lead, gold, gold alloy and mercury. In an exemplary embodiment, the acoustic damper 306 is constructed from tungsten and ceramic and has an acoustic impedance of 99.72 g/cm²-sec10⁵.

The acoustic signal transmitted from the transducer 204 and through the acoustic window 208 can be reflected off a subterranean surface including, but not limited to the wellbore wall 210, subterranean formation, a cement surface, a casing surface, a fracture surface, a fluid surface or a material deposit surface. The wellbore wall 210 has large acoustic impedance and reflects a large portion of the acoustic signal (on the order of about 90%). The time of flight, amplitude and frequency of the acoustic signal reflected off a subterranean surface, protrusion or deposit is measured with the transducers 204 that created the original acoustic signal.

The time of flight data is an indication of the distance between the transducers 204 and the wellbore wall 210 or other subterranean surface. Time of flight can be calculated with the following equation: ToF=2*LN wherein (L) is the distance to the wellbore wall 210 or other subterranean surface and (V) is the acoustic velocity of the acoustic signal through the wellbore fluid. The time of flight data can be used to calculate the diameter of the wellbore at any subterranean depth within the well.

The amplitude of the reflected acoustic signal can be measured by the transducers 204 that created the acoustic signal. The amplitude of the reflected acoustic signal is an indication of the granularity or roughness of the wellbore wall 210. A smooth surface will reflect an acoustic signal with higher amplitude than a rough surface.

The frequency and phase shift of the reflected acoustic signal can also be measured by the transducers 204 that created the acoustic signal. A phase shift in the acoustic signal is an indication of fractures or fissures intersecting the wellbore wall 210.

When performing ultra-sonic acoustic measurements high amplitude and high frequency acoustic waves are favored to magnify the reflected acoustic wave and enhance the spatial resolution of the resulting image. One or more acoustic transducers 204 within the tool 200 can be arranged in an array and fired in sequence to focus the acoustic wave on a subterranean surface. The acoustic wave attenuates as the wave expands moving away from the transducers 204. An acoustic transducer drive circuit can be operatively connected to a processor that is programmed to fire or actuate two or more transducers 204 in a predetermined sequence to create a peak node or amplitude of acoustic energy focused at a particular point on the wellbore wall 210 or other subterranean surface. This is a powerful technique for increasing the acoustic resolution of the resulting image without having to rotate the tool 200 or a component part thereof.

Secondary reflections and refractions will change the phase or frequency of acoustic waves that strike internal surfaces of fractures or other subterranean surfaces. Phase change and frequency data of the reflected wave can provide valuable information regarding the location of fractures and stress field of the rock formation. A processor can be programmed to modify the timing sequence of two or more transducers 204 to move the peak node of acoustic energy across the face of the wellbore wall 210 or other subterranean surface. This technique provides a high degree of azimuth resolution for fracture mapping.

Time of flight, amplitude and frequency data of the acoustic signal can be used to create an image of the wellbore wall 210 or other subterranean surface. The time of flight data, amplitude data, frequency data and image of the wellbore wall 210 can be used to determine the diameter of the wellbore, the contour of the wellbore wall 210, the roughness of the wellbore wall 210, average grain size of a subterranean surface, location and composition of material deposits on a subterranean surface, the location of wash-out zones or wellbore breakouts within the wellbore, the position, depth and direction of fractures intersecting the wellbore wall 210, the location of fluid within fractures intersecting the wellbore wall 210, the location and integrity of bonds and cement along wellbore casing, the location of corrosion or cracking along wellbore casing and the overburden pressure and physical properties of the formation as a function of subterranean depth.

The logging and imaging tool 200 can include an array of transducers 204 arranged on an inner circumference of the tool 200 or tool body 202 to capture time of flight, amplitude and frequency data over a 360 degree circumference of the subterranean well or wellbore. The tool 200 can also be raised and lowered within the well to capture time of flight, amplitude and frequency data over the entire length of the wellbore.

FIG. 3 illustrates a side perspective view of an exemplary subterranean logging and imaging tool 300 according to another embodiment. The tool 300 can be lowered into a subterranean well to image the well, detect formation fractures, measure the diameter of the wellbore, investigate well casing, perforations, slots and screens, or detect corrosion and cracks in cement, well casing or other bonds between the casing, the cement and the formation.

The tool 300 includes a tool body 302 containing a transducer array 304 with several rows and columns of transducers evenly spaced about an internal circumference of the tool body 302. Small relief holes 310 or grooves are cut into the acoustic window 306 near each transducer in the transducer array 304 to reduce the acoustic coupling between adjacent transducers in the array 304. The relief holes 310 can be filled with a high temperature solder such as a gold eutectic solder or solder containing nanometals dispersed in an organic paste.

The tool body 302 can be oblong, cylindrical or spherical shaped. The tool body 302 can be constructed from non-magnetic metal or metal alloys such as steal, titanium, incoloid, ceramic, combinations thereof or other corrosion resistant material with high temperature and pressure ratings. In an exemplary embodiment, the tool body 302 is constructed with a Dewar heat shield.

The tool body 302 is sealed with an acoustic window 306 to protect the transducer array 304 and other electronics from high temperature and/or corrosive well fluids such as heated brine, steam, chlorine, sulfur and/or other corrosive, high temperature fluid within the subterranean well. The acoustic window 306 can be mechanically, electrically and/or acoustically coupled to a surface of one or more transducers in the transducer array 304. In an exemplary embodiment, the acoustic window 306 is mechanically, electrically and acoustically coupled to a front or active surface of one or more transducers in the transducer array 304. Primary acoustic signals used during operation of the tool 300 are emitted from an active surface of the transducers 304.

The acoustic window 306 provides an acoustic medium to transmit acoustic signals generated by the transducer array 304. The acoustic window 306 is constructed from material that is chemically inert with well fluids. The acoustic window 306 is constructed from material with acoustical properties substantially similar to the acoustic properties of the transducers in the array 304. This eliminates or reduces internal reflection within the tool 300. To eliminate or reduce internal reflection within the wellbore, it is also beneficial for the acoustic properties of the acoustic window 306 to be as similar as possible to the acoustic properties of the casing, the formation or cement between the formation and the casing. The acoustic properties (e.g., acoustic impedance) and mechanical properties of the acoustic window 306 are not strongly dependent upon temperature and remain substantially unaltered in temperature ranges encountered in geothermal and engineered geothermal systems. The acoustic window 306 can be constructed from at least one material including, but not limited to titanium, tin, lead alloys, zirconium, gallium-indium alloys, silver alloys, rare earth metals, rare earth metal alloys or other material exhibiting the properties described above.

In an exemplary embodiment, the acoustic properties and mechanical properties of the acoustic window remain substantially unaltered in a temperature range from about ambient temperature to temperatures greater than 275° C.

To eliminate or reduce internal reflection of the acoustic signal within the tool body 302, the acoustic window 306 is placed in direct contact with a surface of the transducer array 304. The coupling of the acoustic window 306 and the transducer array 304 can create acoustical transparency between the acoustic window 306 and the acoustic transducer array 304. The acoustic window 306 can be mechanically, electrically or acoustically bonded or coupled to one or more transducers 304 by soldering the acoustic window 306 to the transducer array 304. A high temperature solder, such as a gold eutectic solder can be placed in the relief holes 310 to further bond the acoustic window 306 to the transducer array 304. In an exemplary embodiment, the acoustic window 306 is mechanically, electrically and acoustically bonded to a front or anterior surface of the transducer array 304 by soldering the acoustic window 308 to the transducer array 304 with a high temperature solder having temperature rating of greater than 325° C.

The exterior surface of the acoustic window 306 can be treated with plated or sputtered metal to facilitate bonding of the solder to the surface of the acoustic window 306. The acoustic window 306 is electrically coupled to an earth ground or circuit common. Therefore, the acoustic window 306 can be in direct contact with corrosive and conductive wellbore fluid without shorting or damaging the tool 300.

In geothermal and enhanced geothermal systems, the wellbore pressure can be equal to and greater than 1000 psi. Therefore, the acoustic window 306 can also be mechanically, electrically and acoustically bonded to one or more acoustic transducers in the array 304 with the use of wellbore pressure.

A posterior or rear surface of the transducer array 304 can be electrically coupled to an active drive circuit 312 that drives one or more transducers in the array 304 to emit acoustic signals or pulses. One or more processors can be operatively connected to drive circuit 312 and a corresponding power supply (not shown) to fire or actuate the transducers in the array 304. The processor can be programmed to actuate one or more transducers in the array 304. The processors can be programmed or provided with software configured to sequence or time the actuation of two or more transducers in the array 304. The sequential actuation of transducers in the array 304 allows the signals to be combined, amplified and focused on a particular spot on a subterranean surface.

To maximize acoustic transparency between the transducer array 304 and the acoustic window 306, the thickness of the acoustic window 304 can be any multiple of ½ or ¼ of the acoustic wavelength (λ). The acoustic wavelength (λ) transmitted from one or more acoustic transducers in the array 304 can range anywhere from about 0.01 mm to 50 mm depending on frequency (f) of the signal pulse and the velocity (V) of the signal traveling through a given well fluid at a given temperature. In an exemplary embodiment, the acoustic frequency (f) of the signal transmitted from one or more transducers in the array 304 is about 1 MHz and the acoustic velocity (V) of the signal through water ranges from 1450 m/s at room temperature to 2680 m/s at 275° C.

An acoustic damper 308 can be mounted to a rear or inactive surface of the transducer array 304 with a high temperature solder. The acoustic damper 308 is constructed from a matrix of acoustically stiff material that drives acoustic signals through the front or active side of the transducer array 304. The impedance mismatch (Z1-Z2) between two or more materials within the acoustic damper 308 deadens or dampens ultrasonic ringing within the tool body 302 and drives the acoustic pulse through the acoustic window 306 and into the wellbore fluid.

The acoustic damper 308 can be constructed from at least one acoustically stiff material including, but not limited to ceramic, tungsten, lead, gold, gold allow or mercury. In an exemplary embodiment, the acoustic damper 308 is constructed from tungsten and ceramic and has an acoustic impedance of 99.72 g/cm²-sec10⁵.

FIG. 4 illustrates an inverted perspective view of an exemplary transducer array 304 according to one embodiment. The transducer array contains one or more transducers 314 separated by a predetermined distance (e.g., 0.03-0.05 inches) to avoid acoustic interference. Each transducer 314 in the array 304 can have solder or a sputtered conductive metal layer on a front and back surface of the transducer 314. The transducers within array 304 can be arranged in a ceramic tube bank 316 including a series of ceramic tubes 318 separated by a predetermined distance on a ceramic back plate 320. Each transducer 314 in the array 304 is placed in a ceramic tube 318 to protect the transducers 314 and dampen ultrasonic ringing within the tool body 302 (shown in FIG. 3). An anterior or active surface of each transducer 318 in the array 304 can be soldered to the acoustic window 306 (shown in FIG. 3) which acts as a common ground for all wired connections. A posterior or rear surface of the transducer array 304 can be electrically coupled with solder to an active drive circuit 312 through the ceramic back plate 320 to drive one or more transducers 314 in the array 304 to emit acoustic pulses or continuous waves.

The ceramic tube bank 316 can also be constructed from at least one acoustically stiff material including, but not limited to ceramic, tungsten, lead, gold, gold alloy or mercury. The ceramic tubes 318 can be backfilled with tungsten and ceramic filler to further dampen internal transducer ringing.

The transducers 314 in the array 304 can be constructed from at least one piezoelectric material including, but not limited to lead zirconate titanate (PZT), tourmaline, topaz, quartz, lead metaniobate (K-83), and bimuth titanate (K-15). The acoustic impedance of these piezoelectric materials is about 25 to 35 g/cm²-sec10⁵.

For high temperature environments, such as geothermal and enhanced geothermal systems, the piezoelectric transducer 314 must have a high Curie temperature (Tc). Once the well temperature exceeds 50% of the Tc, the operating life of the piezoelectric transducer is compromised. K-83 has a Tc of 570° C. and can be used in geothermal and enhanced geothermal systems depending on the number of well exposures. K-83 also has a high acoustic response. K-15 has a Tc of 600° C. and can withstand operating temperatures equal to and greater than 300° C. The acoustic impedance of K-15 is 29.0 g/cm²-sec10⁵. K-15 is suitable for use in geothermal and enhanced geothermal systems.

Referring to FIG. 3 and FIG. 4, the acoustic signal or pulse that is transmitted from the transducer array 304 through the acoustic window 306 can be reflected off a subterranean surface including, but not limited to the wellbore wall, subterranean formation, a cement surface, a casing surface, a fracture surface, a fluid surface or a material deposit surface. The wellbore wall has large acoustic impedance and reflects a large portion of the acoustic signal (on the order of about 90%). The time of flight, amplitude and frequency of the acoustic signal reflected off a subterranean surface, protrusion, fluid or deposit is measured with the transducer array 304 that created the original acoustic signal.

The time of flight data is an indication of the distance between the transducer array 304 and the wellbore wall. The time of flight data can be used to calculate the diameter of the wellbore at any subterranean depth within the well.

The amplitude of the reflected acoustic signal can be measured by the transducer array 304 that created the acoustic signal. The amplitude of the reflected acoustic signal is an indication of the granularity or roughness of the wellbore wall. A smooth surface will reflect an acoustic signal with, higher amplitude than a rough surface.

The frequency and phase shift of the reflected or refracted acoustic signal can also be measured by the transducer array 304 that created the acoustic signal. A phase shift in the acoustic signal is an indication of fractures or fissures intersecting the wellbore wall.

When performing ultra-sonic acoustic measurements high amplitude and high frequency acoustic waves are favored to magnify the reflected acoustic wave and enhance the spatial resolution of the resulting image. One or more acoustic transducers in the transducer array 304 can be fired in sequence to focus the acoustic wave in a particular spot on a subterranean surface. The acoustic wave attenuates as the wave expands moving away from the array 304. An acoustic transducer drive circuit 314 can be operatively connected to a processor that is programmed to fire or actuate two or more transducers in the array 304 in a predetermined sequence to create a peak node or amplitude of acoustic energy focused at a point on the wellbore wall. This is a powerful technique for increasing the acoustic resolution of the resulting image without rotating the tool 300 or rotating a tool part.

Secondary reflections and refractions will change the phase or frequency of acoustic waves that strike internal surfaces of fractures or other subterranean surfaces. Phase change and frequency data of the reflected wave provide valuable information regarding the location of fractures and the stress field of the rock formation. A processor can be programmed to modify the actuation or timing sequence of two or more transducers in the array 304 to move the peak node of acoustic energy across the face of the wellbore wall. This technique provides a high degree of azimuth resolution for fracture mapping.

Time of flight, amplitude and frequency data of the reflected acoustic signal can be used to create an image of the wellbore wall or other subterranean surface. The time of flight data, amplitude data, frequency data and image of the wellbore wall can be used to determine the diameter of the wellbore, the contour of the wellbore wall, the roughness of a subterranean surface, average grain size of a subterranean surface, location and composition of material deposits on a subterranean surface, the location of wash-out zones or wellbore breakouts, the position, depth and direction of fractures intersecting the wellbore wall, the location of fluid within fractures intersecting the wellbore wall, the location and integrity of bonds and cement along wellbore casing, the location of corrosion or cracking on a subterranean surface and the overburden pressure and physical properties of the formation as a function of subterranean depth.

The transducer array 304 is arranged on an inner circumference of the logging tool 300. The tool 300 can capture time of flight, amplitude and frequency data over a 360 degree circumference of the subterranean well or wellbore without rotating the tool 300 or a component part of the tool. The tool 300 can also be raised and lowered within the well to capture time of flight, amplitude and frequency data over the entire length of the wellbore.

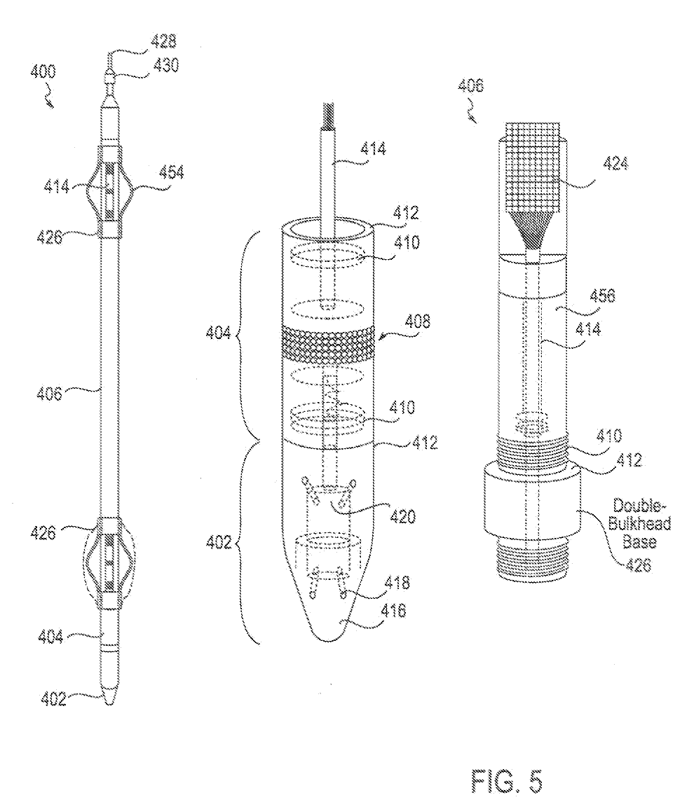

FIG. 5 illustrates a schematic of an exemplary subterranean logging and imaging tool 400 according to another embodiment. The logging and imaging tool 400 can be oblong, cylindrical or spherical shaped. The logging and imaging tool 400 includes a calibration nose 402, an acoustic head 404 and electronics housing 406. The tool 400 can be lowered into a subterranean well to image the well, detect formation fractures, measure the diameter of the wellbore, investigate well casing, perforations, slots and screens, or detect corrosion and cracks in cement, well casing or other bonds between the casing, the cement and the formation.

Bowspring stabilizers 454 can be arranged on the peripheral surface of the tool 400 to centralize, stabilize or otherwise position the tool 400 within the well. The bowspring stabilizers 454 are axially positioned on the tool to minimize disturbance in the flow of fluid past the tool 400. The bowspring stabilizers 454 can be constructed from non-magnetic material.

The acoustic head 404 houses a transducer array 408 containing one or more transducers for emitting acoustic signals. The acoustic head 404 can be constructed from non-magnetic metal or metal alloys including, but not limited to steal, titanium, incoloid, ceramic or other corrosion resistant material with high temperature and pressure ratings. In an exemplary embodiment the acoustic head 404 is constructed from a titanium alloy.

As described in reference to FIG. 3 and FIG. 4, the transducer array 408 can be arranged within a ceramic tube bank (Shown in FIG. 4). Each transducer in the array 408 can be constructed from at least one piezoelectric material including, but not limited to lead zirconate titanate (PLT), tourmaline, topaz, quartz, lead metaniobate (K-83), and bimuth titanate (K-15). The transducer array 408 can include several piezoelectric transducers evenly spaced around a circumference of the acoustic head 404. This eliminates the need to rotate the tool 400 during downhole logging.

The transducer array 408 can include several rows and columns of acoustic transducers evenly spaced around a circumference of the acoustic head 404. In an exemplary embodiment, the transducer array 408 can have 32 or more transducers. In another exemplary embodiment, the transducer array 408 is a 40×5 matrix of 200 transducers.

A lead (not shown) extending from a back surface of each transducer in the array 408 is bundled together and passed through a high temperature wiring tube 414 that extends from the top of the acoustic head 404. The high temperature wiring tube 414 can be constructed from ceramic or other high temperature material. A protective sleeve can also be placed over the high temperature wiring tube 414 for added heat protection.

A high temperature composite fill in liquid form can also be can be used to fill void space within the acoustic head 404 to increase the temperature rating of the acoustic head 404. After setting, the composite fill stabilizes the leads (not shown) extending from each transducer in the array 408. The high temperature composite fill can also provide structural support for the acoustic head 404 and dampen internal transducer ring.

As described in reference to FIG. 2 and FIG. 3, an acoustic window (not shown) can be coupled to the transducer array 408. The acoustic window provides an acoustic medium to transmit acoustic signals generated by the transducer array 408. The acoustic window is constructed from material that is chemically inert with well fluids. The acoustic window is constructed from material with acoustical properties substantially similar to the acoustic properties of the transducers in the array 408. This eliminates or reduces internal reflection within the tool 400. To eliminate or reduce internal reflection within the wellbore, it is also beneficial for the acoustic properties of the acoustic window to be as similar as possible to the acoustic properties of the casing, the formation or cement between the formation and the casing. The acoustic properties (e.g., acoustic impedance) and mechanical properties of the acoustic window are not strongly dependent upon temperature and remain substantially unaltered in temperature ranges encountered in geothermal and engineered geothermal systems. The acoustic window can be constructed from at least one material including, but not limited to titanium, tin, lead alloys, zirconium, gallium-indium alloys, silver alloys, rare earth metals, rare earth metal alloys or other material exhibiting the properties described above.

To eliminate or reduce internal reflection of the acoustic signal within the tool 400, the acoustic window can be mechanically, electrically or acoustically coupled to a surface of the transducer array 408. The coupling of the acoustic window and the transducer array 408 can create acoustical transparency between the acoustic window and the transducer array 408.

The acoustic head 404 includes internal stub acme threads 410 and high temperature metal seals 412 for connecting the top of the acoustic head 404 to the electronics housing 406 and for connecting the bottom of the acoustic head 404 to the calibration nose 402. The metal seals 412 can include c-ring and/or c-ring configurations.

The calibration nose 402 can be constructed from non-magnetic metal or metal alloys including, but not limited to steal, titanium, incoloid, ceramic or other corrosion resistant material with high temperature and pressure ratings. In an exemplary embodiment the calibration nose 402 is constructed from a titanium alloy.

The lower portion of the calibration nose 402 includes an internal hollow calibration space 416 with a substantially half parabolic profile. Two ring holes 418 can be arranged on a surface of the lower portion of the calibration nose 402 to direct well fluid into and out of the internal hollow calibration space 418. A calibration transducer 420 can be mounted within the calibration nose 402 to calibrate the transducer array 408 within the acoustic head 402.

The calibration nose 402 provides a streamlined leading edge for the tool 400 to deliver substantially laminar flow past the transducer array 408 within the acoustic head 404 while logging downhole or in the presence of internal wellbore flows between production intervals.

The calibration nose 402 also serves to calibrate the transducer array 408 within the acoustic head 402 by calculating the acoustic velocity within the well fluid at a specific temperature and depth of logging. This function allows the tool 400 to be calibrated real-time during logging over a wide range of wellbore temperatures and subterranean depths encountered in geothermal and enhanced geothermal systems.

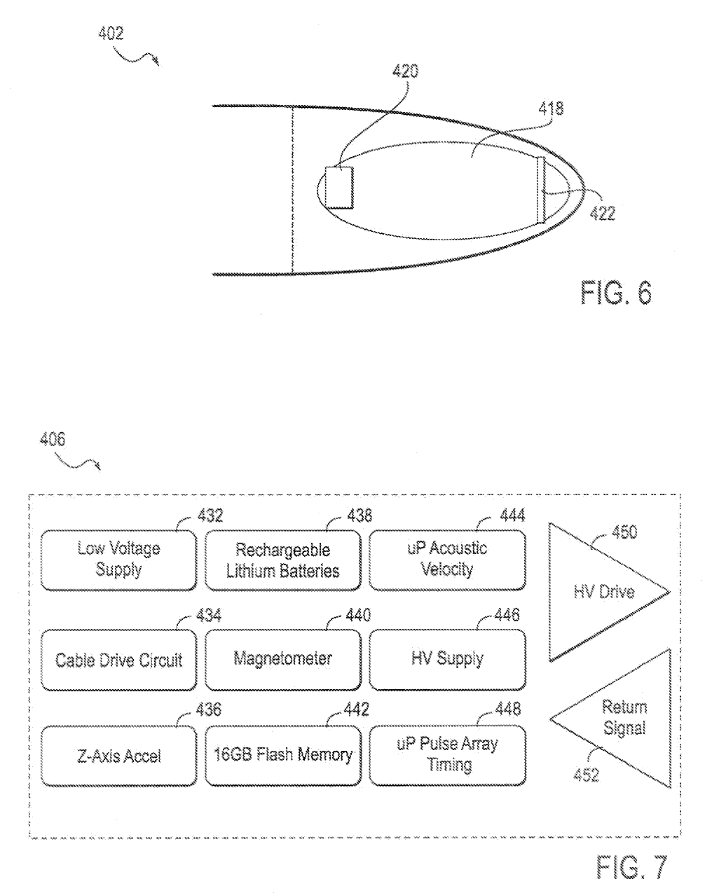

FIG. 6 illustrates a cross sectional view of an exemplary calibration nose 402 according to one embodiment. A calibration transducer 420 can be mounted within the internal hollow calibration space 418 of the calibration nose 402. The calibration transducer 420 can be constructed from at least one piezoelectric material including, but not limited to lead zirconate titanate (PZT), tourmaline, topaz, quartz, lead metaniobate (K-83), and bimuth titanate (K-15).

An active end of the calibration transducer 420 faces towards an acoustic target 422, which is positioned in the internal hollow calibration space 418 a known or predetermined distance from the transducer 420. A thermistor probe (not shown) can also be mounted in the internal hollow calibration space 418 to measure the temperature of the well fluid at a specific depth as the fluid enters the internal hollow calibration space 418 during logging.

The calibration transducer 420 emits an acoustic signal that travels through the well fluid in the internal hollow calibration space 418 and strikes the acoustic target 422. The acoustic signal is reflected back to the calibration transducer, which can measure the time of flight, amplitude and frequency of the reflected acoustic signal. Using the time of flight data, temperature of the well fluid and the known distance to the acoustic target 422, the acoustic velocity within the well fluid at a specific depth and temperature is calculated. One or more processors can be operatively connected to the calibration transducer 420 and the transducer array 408 (shown in FIG. 5) to calibrate the array real-time or while logging by receiving and transmitting calibration data measured by the calibration transducer 420. The sequential actuation and actuation timing intervals of transducers in the transducer array 408 can be specified or determined based, in part, on the acoustic velocity of the calibration signal in the subterranean fluid.

Referring back to FIG. 5, the upper portion of the calibration nose 402 can include stub acme threads 410 and high temperature metal seals 412 for connecting the upper portion of the calibration nose 402 to the acoustic head 404. Leads (not shown) can be connected to the calibration transducer 420 and a thermistor (not shown) and exit the top portion of the bull nose 402 to connect with leads (not shown) extending from the bottom portion of the acoustic head 404. Calibration data including acoustic velocity and well fluid temperature can be transmitted from the calibration nose 402 to the acoustic head 404 through the leads.

The electronics housing 406 houses the majority of electronics required to operate the tool 400. The electronics housing can be constructed from at least one material including, but not limited to steal, titanium, incoloid, ceramic or other corrosion resistant material with high temperature and pressure ratings. In an exemplary embodiment, the electronics housing 406 is constructed from a Dewar heat shield with a temperature rating of greater than 350° C. The electronics in the housing 406 can be high temperature electronics suitable for operation encountered in geothermal and enhanced geothermal systems.

An electronics backbone 424 can be positioned within the electronics housing 406 to protect the electronics from hot, corrosive or conductive wellbore fluid. A double-bulkhead 426 with stub acme threads 410 and metal seals 412 can be positioned on a bottom portion of the electronics housing 406 and a top portion of the acoustic head 404 to connect the electronics housing 406 to the acoustic head 404.

Leads (not shown) from the transducer array 408 and the electronics backbone 424 can be bundled together and passed through one or more high temperature wiring tubes 414 that extend through the electronics housing 406 and the acoustic head 404. The electronics backbone 424 can be safely connected to the transducer array 408 through the high temperature wiring tube 414. The high temperature wiring tube 414 can be constructed from ceramic or other high temperature material. A protective sleeve can also be placed over the high temperature wiring tube 414 for added heat protection.

One or more eutectic blocks 456 can be positioned between the double-bulkhead 426 and the electronics backbone 424. The eutectic block includes a container filled with high temperature eutectic material to provide an axially aligned thermal layer within the electronics housing 406. The eutectic block 456 changes phases when operating and well temperatures increase. The heat conducted through the electronics housing 406 is absorbed through the phase change of the eutectic material to further shield the electronics backbone 424 from high temperature within the well.

The top portion of the electronics housing 406 is closed off or sealed with another double-bulkhead 426. All leads from the electronics housing 406 and the acoustic head 404 can be run through one or more high temperature wiring tubes 414 over the entire length of the tool 400. The high temperature wiring tube 414 can be connected to a single conductor wire line 428 through an axial cable head connector 430. All data, measurements and/or calculations collected or performed by the logging and imaging tool 400 can be transmitted to the surface for processing and diagnostics through the single conductor wire line 428.

FIG. 7 illustrates: a schematic of an exemplary electronics housing 406 according to one embodiment. The electronics housing 406 can house high temperature processors, power supplies, circuits and other diagnostic equipment required to operate the tool 400 and collect data from the well.

Referring to FIG. 5 and FIG. 7, a low voltage power supply 432 can be provided to supply low voltage to the single conductor wire line 428 and other leads within the tool. Low voltage power and data can be transmitted over the line 428 and other leads simultaneously. A cable drive circuit 434 drives power through the single conductor wire line 428 during data and power transmission. The cable drive circuit 434 allows variations in communication rate. When the tool 400 is at the surface the communication rate through the single conductor wire line 428 can be modified from 50 Kbits to 10 Kbits. High temperature rechargeable lithium batteries 438 can be included within the electronics housing 406 to reduce the overall power requirement of the tool 400 or to reduce the noise floor for the return signal circuit 452.

A z-axis accelerometer 436 can be provided to track any acceleration as the tool 400 is moved up and down the well during logging. Acceleration caused by contact of the tool 400 or bowspring stabilizers 454 with the wellbore wall can be measured to determine the actual distance traveled by the tool 400.

A magnetometer 440 is used to provide azimuth readings during logging. Each azimuth reading can be associated with one or more transducer measurements performed by the tool 400. In an exemplary embodiment, the magnetometer 440 is a solid-state magnetic resistive compass. The magnetometer 440 can be electrically coupled to a single transducer in the array 408 and azimuth readings can be transmitted to associate one or more transducer readings with a corresponding azimuth reading. In an exemplary embodiment, one azimuth reading is recorded and associated with every 360 degree acoustic measurement performed by the transducer array 408. Because the acoustic array 408 is stationary during operation, the magnetometer 440 can be physically connected to the array 408.

One or more 8 GB, 16 GB or 160 GB flash memories 442 can be provided within the electronic housing 406 to locally store all or a portion of data, measurements and/or calculations collected or performed by the logging and imaging tool 400.

An acoustic velocity circuit 444 can be provided in the electronic housing 406 to drive the calibration transducer 420 within the calibration nose 402. A microprocessor within the acoustic velocity circuit 444 can time the returning reflection of the calibration signal. The actual acoustic velocity of the wellbore fluid can be directly measured with the acoustic velocity circuit 444 to a resolution of 50 nS.

Piezoelectric transducers within the array 408 require a high voltage driver 450 in order to generate the needed acoustic response. The high voltage driver 450 can actively drive the transducers in the array 408 over many cycles of 1 MHz frequency or other frequency. This allows the tool 400 to operate in many different acoustic sensing modes or modalities. In one mode of operation, a single pulse is provided for caliper-type measurements. In another mode of operation, a continuous acoustic sine wave signal is provided for fluid Doppler-type measurements.

The high voltage driver 450 can receive instructions from a microprocessor inside the pulse array timing circuit 448. The microprocessor can provide wellbore diameter data and acoustic velocity data to the high voltage driver 450. The processor can be programmed or provided with software configured to drive the high voltage driver 450 with a high voltage power supply 446. The processor can be programmed or provided with software configured initiate a predetermined emission sequence of acoustic pulses or acoustic waves from two or more transducers in the array 408. A combined acoustic signal can be focused on a specific spot on subterranean surface using this method of automated sequenced timing of acoustic emissions from the transducer array 408.

A high voltage power supply 446 (e.g., 70-100 V) can power the high voltage driver 450. In an exemplary embodiment, the high voltage power supply 446 includes a SiC power transistor operating at greater than 100 KHz. This reduces the internal heating by 30-50% and facilitates easy filtering for noise reduction.

The pulse array timing circuit 448 uses the wellbore diameter measurements and the acoustic velocity measurements as inputs in an internal microprocessor to determine the correct timing interval or firing sequence required to focus a series of acoustic signals emitted from the acoustic array 408. The processor within the pulse array timing circuit 448 can be programmed or provided with software configured to determine or output the correct timing required to produce a combined acoustic signal on a spot size equal to or less than 1 mm on the wellbore wall. The actuation sequence or timing interval can be determined based on the acoustic velocity measured during calibration using the calibration transducer 420 described above.

The return signal circuit 452 is an amplifier and digital converter. The return signal circuit 452 can be part of the pulse array timing circuit 448. In an exemplary embodiment, the digital converter is capable of 16 bits at 20 MHz. This will allow for significant over sampling and the dynamic range for high-fidelity signal capture necessary to detect and process acoustic phase shifts and reflections caused from fractures found deep in the formation. The return signal circuit 452 receives window timing data from a microprocessor in the acoustic velocity circuit 444. To save tool memory and processing time, digital sampling only occurs when returning signals are expected to reach the transducer array 408.

Referring again to FIG. 5 and FIG. 7, the acoustic signals transmitted from the transducer array 408 can be reflected off a subterranean surface including, but not limited to the wellbore wall, subterranean formation, a cement surface, a casing surface, a fracture surface, a fluid surface or a material deposit surface. The time of flight, amplitude and frequency of the acoustic signal reflected off a subterranean surface, protrusion, fluid or deposit is measured with the transducer array 408 that created the original acoustic signal.

The time of flight data is an indication of the distance between the transducer array 408 and the wellbore wall. The time of flight data can be used to calculate the diameter of the wellbore at any subterranean depth within the well.

The amplitude of the reflected acoustic signal can be measured with the transducer array 408 that created the acoustic signal. The amplitude of the reflected acoustic signal is an indication of the granularity or roughness of the wellbore wall. A smooth surface will reflect an acoustic signal with higher amplitude than a rough surface.

The frequency and phase shift of the reflected acoustic signal can also be measured with the transducer array 408 that created the acoustic signal. A phase shift in the acoustic signal is an indication of fractures or fissures intersecting the wellbore wall.

When performing ultra-sonic acoustic measurements high amplitude and high frequency acoustic waves are favored to magnify the reflected acoustic wave and enhance the spatial resolution of the resulting image. One or more acoustic transducers in the transducer array 408 can be fired in sequence to focus the acoustic wave in a particular spot on a subterranean surface. The acoustic wave attenuates as the wave expands moving away from the array 408. An acoustic transducer driver 450 can be operatively connected to a processor that is programmed to tire or actuate two or more transducers in the array 304 in a predetermined sequence to create a peak node or amplitude of acoustic energy focused at a point on the wellbore wall. This is a powerful technique for increasing the acoustic resolution of the resulting image without rotating the tool 400 or rotating a tool part.

Secondary reflections and refractions will change the phase or frequency of acoustic waves that strike internal surfaces of fractures or other subterranean surfaces. Phase change and frequency data of the reflected wave provide valuable information regarding the location of fractures and the stress field of the rock formation. A processor can be programmed to modify the actuation interval or timing sequence of two or more transducers in the array 408 to move the peak node of acoustic energy across the face of the wellbore wall. This technique provides a high degree of azimuth resolution for fracture mapping.

Time of flight, amplitude and frequency data of the reflected acoustic signal can be used to create an image of the wellbore wall or other subterranean surface. The time of flight data, amplitude data, frequency data and image of the wellbore wall can be used to determine the diameter of the wellbore, the contour of the wellbore wall, the roughness of a subterranean surface, average grain size of a subterranean surface, location and composition of material deposits on a subterranean surface, the location of wash-out zones or wellbore breakouts, the position, depth and direction of fractures intersecting the wellbore wall, the location of fluid within fractures intersecting the wellbore wall, the location and integrity of bonds and cement along wellbore casing, the location of corrosion or cracking on a subterranean surface and the overburden pressure and physical properties of the formation as a function of subterranean depth.

The transducer array 408 is arranged on an inner surface or circumference of the logging tool 400. Therefore, the logging and imaging tool 400 can capture time of flight, amplitude and frequency data over a 360 degree circumference of the subterranean well or wellbore without rotating the tool or a component part of the tool 400. The imaging and logging tool 400 can be raised and lowered within the well to capture time of flight, amplitude and frequency data over the entire length of the wellbore.

In an exemplary embodiment, measurements and raw data provided by the tool 400 including, but not limited to time of flight data, amplitude data, frequency data, temperature data, pressure data, depth data, calibration data and acoustic velocity data can be stored locally in internal memory devices 442 within the tool 400. The measurements and raw data can also be transmitted through a single conductor wire line 428 and processed at the surface real-time as they are provided by the tool 400.

The tool 400 can also be brought to the surface and the measurement data can be recovered in MS PC binary format, digital format or other format that is compatible with other commercial logging software and software interfaces. In an exemplary embodiment, data collected with the logging and imaging tool 400 is transmitted real time to a logging vehicle 106 (shown in FIG. 1) and used as input in commercial logging software operating on one or more processors. For instance, time of flight data, amplitude data and acoustic velocity data can be provided as inputs for Warrior Well Logging System for real-time logging and imaging of the well. A series of acoustic reflections can be received and analyzed at the transducer array 408 to calculate an average or bulk acoustic velocity at a specific subterranean depth. The average or bulk acoustic velocity can be used as input to the Warrior Well Logging System. Images can be created real-time with the use of time of flight, amplitude and acoustic velocity data to determine areas of interest within the formation while logging.

The imaging and logging tool 400 can operate in high temperature well fluids such as water, brine, chlorine, sulfur, oil, hydrocarbons, steam and air. In geothermal and enhanced geothermal applications the well fluids can be equal to and greater than 260° C. In an exemplary embodiment, the imaging and logging tool 400 has a temperature rating equal to or greater than 260° C.

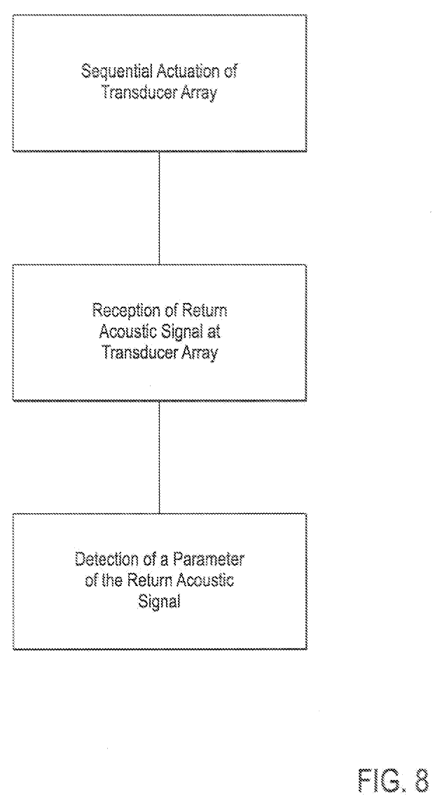

FIG. 8 illustrates a flow chart of an exemplary method for imaging a subterranean surface. The subterranean surface can be any surface in a subterranean or geothermal well including, but not limited to a formation surface, a wellbore wall surface, a cement surface, a casing surface, a fracture surface or a material deposit, such as scaling.

A transducer array can be provided within an imaging and logging tool, such as the imaging and logging tools disclosed herein. The transducer array can include several transducers evenly spaced in rows and columns about an inner circumference of the tool. At least two transducers in the transducer array can be sequentially actuated to emit primary acoustic signals in specific actuation intervals. The transducers can be sequentially actuated in various acoustic modalities, such as a single acoustic pulse signal or a continuous acoustic sine wave signal.

The acoustic signals travel through subterranean fluid and reflect oil a subterranean surface. Fluid within the subterranean well can include, but is not limited to water, brine, chlorine, sulfur, oil, hydrocarbons, steam or air. The subterranean fluid can have a temperature equal to or greater than 260° C. in geothermal and enhanced geothermal applications.

The actuation intervals are selected to cause the primary acoustic signals to constructively combine on a target subterranean surface. A return acoustic signal reflected or refracted from the target subterranean surface is received at the transducer array. At least one parameter of the return acoustic signal is detected at the transducer array to generate an image of the target subterranean surface. The amplitude, frequency and time of flight of the return acoustic signal can be detected at the transducer array to generate an image of the target subterranean surface.

One or more processors within the tool can be programmed or provided with software configured to sequentially actuate the transducers and receive and transmit logging data, such as parameters of the return acoustic signal or parameters of the well fluid.

The method can further include actuating a calibration transducer to emit a primary acoustic calibration signal through the subterranean fluid and against a calibration target positioned a known distance away from the calibration transducer. A return acoustic calibration signal reflected from the calibration target is received at the calibration transducer. At least one parameter of the return acoustic calibration signal, such as amplitude, frequency and time of flight can be detected to determine the acoustic velocity of the return acoustic calibration signal in the subterranean fluid. The actuation intervals of the transducer array can be selected based on the acoustic velocity of the calibration signal traveling through the subterranean fluid.

One or more processors within the tool can be programmed or provided with software configured to perform the calibration by actuating the calibration transducer, receiving logging data and transmitting logging data, such as parameters of the return acoustic signal or parameters of the well fluid.

Data collected by an imaging and logging tool performing the method described above can be transmitted to the surface for processing with commercial logging software. Time of flight data, amplitude data and acoustic velocity data can be provided as inputs for Warrior Well Logging System real-time as the data is collected with the tool. Images can be created real-time with the use of time of flight, amplitude and acoustic velocity data to determine areas of interest within the formation while logging. Time of flight data, amplitude data, frequency data and other data collected by the tool can also be stored in local memory within the tool for subsequent processing at the surface.

Example embodiments have been described hereinabove regarding improved systems and methods for subterranean imaging and logging. Various modifications to and departures from the disclosed example embodiments will occur to those having ordinary skill in the art. The subject matter that is intended to be within the spirit of this disclosure is set forth in the following claims.

1. A subterranean tool comprising:
a tool body;
at least one transducer for generating an acoustic signal; and
an acoustic window coupled to the at least one transducer.

2. The subterranean tool as recited in claim 1, wherein the acoustic window is coupled to an active surface of the at least one transducer.

3. The subterranean tool as recited in claim 1, wherein the acoustic window is mechanically and electrically coupled to an active surface of the at least one transducer.

4. The subterranean tool as recited in claim 1, further comprising an acoustic damper mechanically coupled to the at least one transducer.

5. The subterranean tool as recited in claim 4, wherein the acoustic damper is mechanically coupled to an inactive surface of the at least one transducer.

6. The subterranean tool as recited in claim 1, wherein the transducer is constructed from at least one piezoelectric material selected from the group consisting of: lead zirconate titanate (PZT), tourmaline, topaz, quartz, lead metaniobate (K-83), and bimuth titanate (K-15).

7. The subterranean tool as recited in claim 1, wherein the acoustic window is constructed from at least one material from the group consisting of: titanium, tin, lead alloys, zirconium, gallium-indium alloys, silver alloys, rare earth metals, rare earth metal alloys.

8. The subterranean tool as recited in claim 4, wherein the acoustic damper is constructed from at least one material selected from the group consisting of: ceramic material, tungsten, lead, gold, gold alloys, and mercury.

9. The subterranean tool as recited in claim 1, wherein the thickness of the acoustic window is a ¼ multiple of the acoustic wavelength (λ) of the acoustic signal.

10. The subterranean tool as recited in claim 1, wherein the subterranean tool has a temperature rating equal to or greater than 260° C.

11. A method for imaging a subterranean surface comprising:
sequentially actuating at least two transducers in a transducer array to emit primary acoustic signals in actuation intervals, wherein the actuation intervals are selected to cause the primary acoustic signals to travel through a subterranean fluid and constructively combine on a target subterranean surface;
receiving, at the transducer array, a return acoustic signal reflected or refracted from the target subterranean surface; and
detecting at least one parameter of the return acoustic signal to generate an image of the target subterranean surface.

12. The method as recited in claim 11, wherein the at least one parameter of the return acoustic signal is selected from the group consisting of: an amplitude of the return acoustic signal, a frequency of the return acoustic signal and a time of flight of the return acoustic signal.

13. The method as recited in claim 11, wherein sequentially actuating at least two transducers comprises sequentially actuating the at least two transducers in at least one acoustic modality.

14. The method as recited in claim 13, wherein the acoustic modality is at least one of a single acoustic pulse signal and a continuous acoustic sine wave signal.

15. The method as recited in claim 11, wherein the target subterranean surface is a subterranean formation surface, a wellbore wall surface, a cement surface, a casing surface, a fracture surface or a material deposit surface.

16. The method as recited in claim 11, further comprising actuating a calibration transducer to emit a primary acoustic calibration signal through the subterranean fluid and against a calibration target positioned a known distance away from the calibration transducer.

17. The method as recited in claim 16, further comprising:
receiving, at the calibration transducer, a return acoustic calibration signal reflected from the calibration target; and
detecting at least one parameter of the return acoustic calibration signal to determine the acoustic velocity of the return acoustic calibration signal in the subterranean fluid.

18. The method as recited in claim 17, wherein the at least one parameter of the return acoustic calibration signal is selected from the group consisting of: an amplitude of the return acoustic calibration signal, a frequency of the return acoustic calibration signal and a time of flight of the return acoustic calibration signal.

19. The method as recited in claim 11, wherein the subterranean fluid comprises at least one compound selected from the group consisting of: water, brine, chlorine, sulfur, oil, hydrocarbons, steam and air.

20. The method as recited in claim 19, wherein the subterranean fluid has a temperature equal to or greater than 260° C.

21. (canceled)
